(19) United States
(12) Patent Application Publication
(10) Pub. No.: US 2013/0037291 A1
(43) Pub. Date: Feb. 14, 2013

(54) Device for Precisely Controlling Negative Pressure

(71) Applicant: Meinhard Schwaiger, Linz (AT)

(72) Inventor: Meinhard Schwaiger, Linz (AT)

(21) Appl. No.: 13/634,126

(22) PCT Filed: Mar. 11, 2011
(86) PCT No.: PCT/EP2011/053701

§ 371 Date: Oct. 18, 2012

(30) Foreign Application Priority Data
Mar. 11, 2010 (AT) A 394/2010
May 4, 2010 (AT) A 757/2010

(51) Int. Cl. B23B 45/04

(52) U.S. Cl. 173/168

(57) ABSTRACT

A device for controlling the negative pressure in tools (2, 2′, 3) for calibrating extruded profiles (1) made of synthetic material includes at least one vacuum pump (7), a vacuum container (8) and at least one control valve (4, 4′) for adjusting the negative pressure in the tool (2, 2′, 3). A particularly low energy consumption and improved control behavior are achieved by designing the control valve as a servo valve which is connected to the tool (2, 2′, 3) via a control line (5, 5′). In order to improve the quality of the calibrated profile, the cooling water flowing back and the vacuum are delivered separately, and a water level control unit (14) is used to prevent air from reaching the water return line (11).

The invention relates to an apparatus for precisely controlling the negative pressure in tools for calibrating extruded plastic profiles, comprising at least one vacuum pump, a vacuum container and the control valve for adjusting the negative pressure in the tool.

The present invention relates especially to an improved system for the automated precise control of the vacuum supply of calibrating tools and the automated adjustment of the water quantity to the actual demand for achieving the required cooling performance in producing profiles made of plastic in the extrusion process. Calibrating tools for plastic profiles are used for the defined cooling and shaping of the profile strand formed in an extrusion die and comprise at least one dry calibrating tool and at least one calibrating tank (wet caliber), which can also be placed under vacuum, but with a vacuum level which deviates from the dry calibrating tool. At least one vacuum pump is provided for generating the vacuum, which pump is in connection with the calibrating tool and the vacuum level in the dry caliber or in the calibrating tank is controlled to the preselected setpoint value by means of a control valve.

Systems correspond to the state of the art in which one or several dry calibrating tools or wet calibers are in connection with one or several vacuum pumps. The vacuum level will be controlled by means of supplying air to the vacuum system. A vacuum pump and an air-supply valve is necessary for each vacuum control zone. The disadvantageous aspect in such systems is the high energy consumption (a major part of the energy required for generating the vacuum will be destroyed by means of the air supply into the vacuum system) and the enormous noise generation. Systems with a central water supply or supply pumps installed for each calibrating installation are known for cooling the calibrating tools, which systems are set to nominal capacity irrespective of the actual demand for cooling.

Systems with controllable valves and a central vacuum have been proposed for reducing the energy losses, e.g. in AT 006.407 U. Several vacuum pumps are connected in these systems to a central vacuum system integrated in the installation, and several vacuum control zones are supplied with vacuum from there. The control of the vacuum occurs in the manner that a controllable valve is provided for each vacuum control zone which can be triggered manually or in an automated manner, so that the vacuum level is influenced by changing the cross section of the effective flow cross-section in the valve. One or several vacuum pumps are connected to the central vacuum tank. If more than one vacuum pump is connected, the energy consumption can be influenced in such systems in such a way that in the central vacuum tank the vacuum level can be adjusted by leap to the actual demand situation by activating/deactivating individual vacuum pumps. These systems have the following disadvantages:
the fact that the control valves need to be newly set after each activation/deactivation of vacuum pumps, which leads to additional permanent monitoring and manipulation work for the operating staff;
the lack of sensitivity in the setting of the vacuum level because the power for generating the vacuum will only occur by activating/deactivating individual pumps;
the lack of the savings effect in the power demand because all activated vacuum pumps will always run under full load.

Cooling systems on the basis of uncontrolled feed pumps (centrifugal pumps) convey with constant power irrespective of the required demand for cooling capacity, with the non-required fraction being lost as blind conveying capacity.

One solution which partly avoids the aforementioned disadvantages has been described in U.S. Pat. No. 5,340,295 A. This system is very costly and complex, and shows a highly unsatisfactory control behavior.

A further disadvantage of the known systems occurs especially in high-performance extrusion. When producing high-quality hollow-chamber profiles made of plastic in the high-performance range, i.e. at extrusion speeds of more than 5 m/min, special demands are placed on the vacuum supply. Even slight fluctuations in the vacuum level in the dry or wet caliber will lead to influences on the dimensional accuracy of the profile.

It is the object of the present invention to reliably avoid these disadvantages and to describe a system with which considerably lower energy consumption can be achieved in combination with improved control behavior at the same time.

This object is achieved in accordance with the invention such a way that the vacuum is generated in a central vacuum container according to the respective demand, wherein the vacuum pump can be power-controlled over a wide range and controllable valves are provided between the central vacuum container and the vacuum consumer. These controllable valves are preferably arranged as servo valves which are supplied with a setpoint input and perform a permanent pressure calibration by means of a sensor line between the actual pressure and the setpoint pressure. The discharge of the cooling water occurs separately from the vacuum in the wet caliber. It is prevented by means of level control in the wet caliber or by means of an intermediate valve that air will reach the water suction line and can lead to pressure fluctuations which can be seen on the extruded profile as “beats”. This ensures a constant vacuum level in the consumer, irrespective of pressure fluctuations in the system. This allows guaranteeing a defined vacuum level for each individual consumer in the system (calibrating zone). The generation of the vacuum occurs by way of a power-controlled vacuum pump whose speed is adjusted automatically to the respective current situation. This leads to a closed system with very low power consumption, which is lower by approximately 50% to 90% over conventional systems.

A speed-controlled feed pump is provided for the cooling water supply, the control signals of which are predetermined by the actually required output and the required cooling water pressure.

It is especially advantageous in connection with the present invention when separate suction is provided from the wet caliber, namely a water suction line and a vacuum line. The vacuum line is in connection with the vacuum system and is primarily provided for the purpose of producing the required negative pressure in the wet caliber by suction of air. The water suction line primarily conveys water and produces the desired cooling effect in the wet caliber in this manner. A substantial improvement in the quality of the control can surprisingly be achieved by this measure.

A means for controlling the water level in the wet caliber is provided in an especially advantageous way, which means can be arranged especially as a floating switch for example. The pressure conditions can be set in an especially constant way in this manner in order to increase the dimensional accuracy and precision of the extruded profile. It is especially further advantageous in this connection when the means for controlling the water level is set to a target level and that the orifice of the vacuum line is arranged above the target level and the orifice of the water suction line is arranged beneath the target level. It is substantially ensured in this manner that substantially single-phase media are present in the mentioned lines.

It is alternatively possible that an intermediate container is provided for water suction from the wet caliber, which intermediate container is connected to the vacuum tank by means of the vacuum line and the water suction line. The required power of the water pumps can be reduced in this manner.

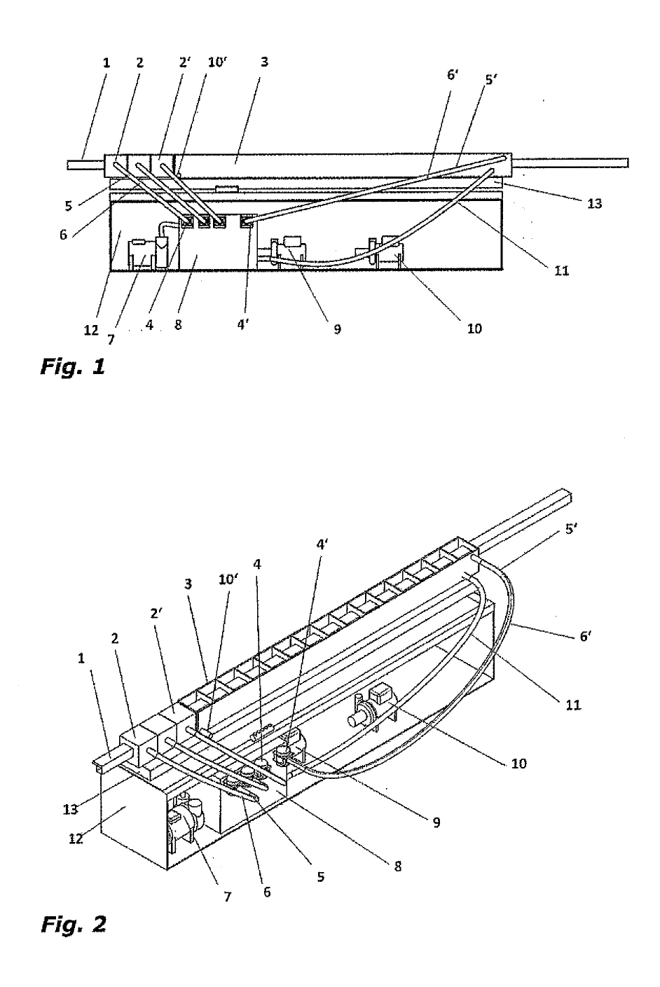

The present invention will be explained in closer detail below by reference to embodiments shown in FIGS. 1 to 5, wherein:

FIG. 1 schematically shows an extrusion installation from the side with the apparatus in accordance with the invention;

FIG. 2 shows an extrusion installation in an axonometric view from above;

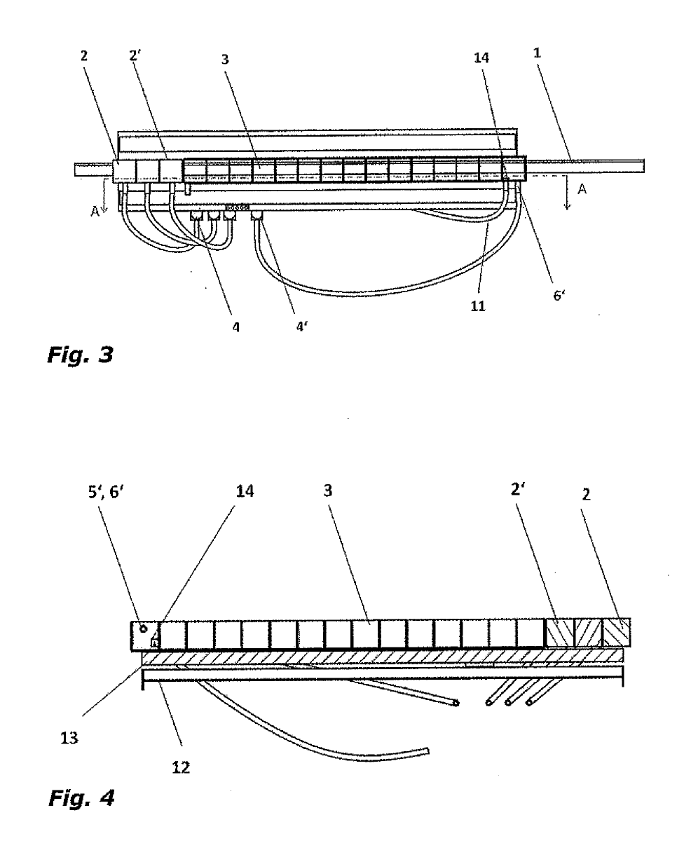

FIG. 3 shows an extrusion installation from above;

FIG. 4 shows a detailed view of the level control in the wet caliber in a sectional view along the line of intersection A-A in FIG. 3; and

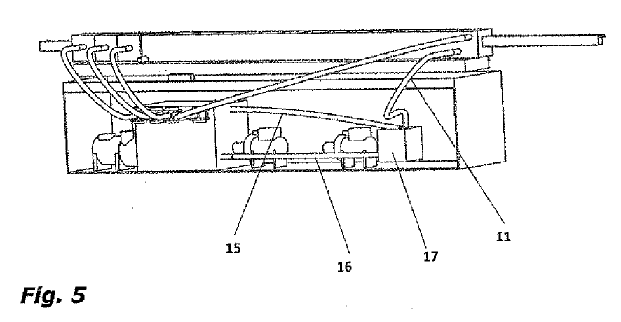

FIG. 5 shows a further embodiment of an extrusion installation in a side view with a water level control in the wet caliber.

FIG. 1 shows that a plastic profile 1 is conventionally guided at first through dry calibration tools 2, 2′ and subsequently through one or several wet calibration (tools) 3. Vacuum pumps 7, which are connected to a vacuum container 8, generate the required negative pressure. Control valves 4, 4′ are connected via suction lines 6, 6′ to the dry calibration tools 2, 2′ or the calibration tank (wet caliber) 3 in order to generate the required negative pressure for calibration in the interior of said components. Each control valve 4, 4′ is associated with a control line 5, 5′ for detecting the pressure in the tool 2, 2′, 3. The control lines 5, 5′ are used for detecting the actual pressures for the servo valves and calibrate the same to the setpoint values by means of the control. A cooling water system 10, 10′ is provided in the known manner within the extrusion installation 12 in addition to the vacuum system. The die system is arranged on the die holder 13 of the extrusion installation 12. The cooling water which is supplied via the feed opening 10′ is removed from the wet caliber 3 by means of the water suction line 11.

FIGS. 3 and 4 show a preferred variant of a water level control 14, which is arranged as a floating switch in order to ensure that only cooling water will reach the water suction line.

FIG. 5 shows a further embodiment of a water level control, consisting of the water suction line 11, and intermediate tank 17 which is supplied with a vacuum from the vacuum container 8 by means of the supply line 15 and the continued water suction line 16, by means of which the returning cooling water is sucked into the vacuum container 8.

1. An apparatus for controlling the negative pressure in calibration tools for calibrating extruded plastic profiles, comprising at least one vacuum pump, a vacuum container and the control valve for setting the negative pressure in the tool, wherein the control valve is arranged as a servo valve which is connected via a control line with the tool.

2. The apparatus according to claim 1, wherein the servo valve is a membrane valve.

3. The apparatus according to claim 1, wherein the control valve comprises a means for setting the negative pressure.

4. The apparatus according to claim 1, wherein the vacuum pump is speed-controlled.

5. The apparatus according to claim 1, wherein the returning cooling water and the vacuum need to be sucked off separately from the wet caliber by means of the water suction line and the vacuum line.

6. The apparatus according to claim 1, including a means in the wet caliber for controlling the water level.

7. The apparatus according to claim 6, wherein the means for controlling the water level is set to a target level and an orifice of the water suction line is provided beneath a target level and an orifice of the vacuum line is provided above said target level.

8. The apparatus according to claim 1, including an intermediate container for water suction from the water caliber, which intermediate container is connected to the vacuum tank by means of the vacuum line and the water suction line.
